(19) United States
(12) Patent Application Publication
(10) Pub. No.: US 2015/0101926 A1
(43) Pub. Date: Apr. 16, 2015

(54) Electrolytic Cell

(71) Applicant: Steve Daniel BURNS, (US)

(72) Inventor: Steve Daniel Burns, Gooseberry Hill (AU)

(21) Appl. No.: 14/401,650

(22) PCT Filed: May 17, 2013
(86) PCT No.: PCT/AU2013/000514

§ 371 Date: Nov. 17, 2014

(30) Foreign Application Priority Data
May 18, 2012 (AU) 2012902065

(51) Int. Cl. F02B 43/12; C25B 1/04; C25B 9/06

(52) U.S. Cl. CPC F02B 43/12; C25B 9/06; C25B 1/04; F02B 2043/106
USPC 204/277

(57) ABSTRACT

An apparatus for producing a combustible gas for use in enhancing or supplementing a fuel supply of an internal combustion engine comprising an electrolytic cell defining a first electrolyte flow path from an upper chamber to a lower chamber and a second electrolysis gas flow path from the lower chamber to a gas trap disposed in the upper chamber. The gas trap arranged to be in fluid communication with an internal combustion engine intake manifold for supplying combustible electrolytic gases produced in the electrolytic cell apparatus to the fuel supply. Further disclosed is a system comprising an electrolyte flow circuit and control unit for use with the apparatus for maintaining optimal operational parameters of the electrolyte undergoing an electrolytic reaction. The system arranged to regulate a flow rate and temperature range of the electrolyte for improving production of combustible gases within the apparatus.

### FIELD OF THE INVENTION

The present invention relates to an electrolytic cell and in particular to an electrolytic cell for use in producing hydrogen gas and oxygen gas from water to supplement a fuel supply for an internal combustion engine.

### BACKGROUND TO THE INVENTION

It is known to use an electrolytic cell to break molecules of water into their elemental constituents of hydrogen and oxygen. In known electrolytic cells an electric current is passed through water and breaks the water molecules apart thereby releasing hydrogen and oxygen gas. Mixtures of the gases produced from the electrolysis reaction have otherwise been known as oxyhydrogen, HHO gas or Browns gas.

Known electrolytic cells have been used for lighting and welding operations for example, however due to the explosive nature of hydrogen gas problems with the safety of such devices exist. These devices are no longer used and are typically replaced by devices using conventional electrical power sources.

It is also known to supplement and/or enhance an internal combustion engine with a hydrogen fuel source for improving the fuel economy and/or power of the engine. This has proved possible with pre-produced hydrogen stored under pressure on the vehicle; however the economies of this method are inefficient. In alternative configurations hydrogen gas can be generated on board from an electrolytic cell with various methods attempted to supplement traditional fossil fuels with the on board hydrogen fuel supply however such attempts have met with limited success. Problems with existing methods relate to limitations of the amount of gas produced in an electrolytic cell on board a vehicle being relatively minor compared with to the fuel consumed by the internal combustion engine. Problems also exist due to the amount of energy required to produce the hydrogen gas in existing cells being greater than the energy released during combustion of the gas in use. The explosive nature of hydrogen gas also poses a safety problem with known electrolytic cells used in on board hydrogen production.

The present invention attempts to overcome at least in part the aforementioned disadvantages of previous electrolytic cells.

The present invention provides a safer and more efficient means for producing on board hydrogen gas for use in internal combustion engine fuel enhancement.

### SUMMARY OF THE INVENTION

In accordance with one aspect of the present invention there is provided an apparatus for use in fuel enhancement for an internal combustion engine, the apparatus comprises an electrolytic cell arranged to have an upper portion, a centre plate, and a lower portion, the upper portion comprises a gas trap, the centre plate adapted to provide a first flow path for a flow of electrolyte fluid to pass from the upper portion to the lower portion, and a second flow path for electrolysis gases to pass from the lower portion to the gas trap, the lower portion comprising a plurality of electrode plates arranged to be in communication with a source of electrical energy and substantially immersed in the electrolyte fluid, wherein the flow of electrolyte fluid passes from the upper portion to the lower portion for undergoing an electrolysis reaction to form electrolysis gases which pass through the second flow path to the gas trap and extracted from the electrolytic cell apparatus.

In accordance with a further aspect of the present invention there is provided a system comprising a fluid circuit between a fluid inlet and a fluid outlet arranged in fluid communication with a pump, and a heat exchanger thereby providing a fluid circuit for moving, and regulating a temperature of the electrolyte contained within the electrolytic cell.

Preferably the electrolyte comprises water, and preferably a distilled water. Preferably the fluid circuit comprises a filter for cleaning the flow of electrolyte.

Preferably the system comprises a control unit adapted to measure, control and/or adjust any one or more system variables including an electrical current and/or voltage supplied to the plurality of electrode plates, an electrolyte fluid flow rate, an electrolyte temperature and a electrolyte level within the electrolyte cell.

Preferably the control unit further comprises a display unit for providing a visual representation of the system to an operator and an interface for manual control or adjustment of a system variable.

Preferably the gas trap comprises a pressure relief valve.

Preferably the electrolyte undergoing electrolysis within the electrolytic cell has a temperature within the range 45-60° C., and preferably has a temperature of 46° C.

Preferably the electrode plates comprise a titanium material, and/or an iridium based conductive material. Preferably a majority of the plates comprise a titanium material.

### BRIEF DESCRIPTION OF THE DRAWINGS

The present invention will now be described, by way of example, with reference to the accompanying drawings, in which:

FIG. 1 is a sectional and exploded view of an electrolytic cell according to a preferred embodiment of the apparatus of present invention, showing an upper portion, a centre plate and a lower portion;

FIG. 2 is an upper perspective view of the upper portion of FIG. 1;

FIG. 3 is a sectional view along the axis AA of the upper portion of FIG. 1;

FIG. 4 is a sectional view of a centre plate of the electrolytic cell of FIG. 1 showing an inlet water trap feature;

FIG. 5 is a lower plan view of the centre plate of FIG. 4;

FIG. 6 is an upper perspective view of the centre plate of FIG. 4;

FIG. 7 is an upper perspective view of a cap of an electrolytic cell according to a preferred embodiment of the present invention;

FIG. 8 is a lower perspective view of the cap of FIG. 7;

FIG. 9 is a lower perspective view of the lower portion of FIG. 1;

FIG. 10(a) is a side view of the lower portion of FIG. 1;

FIG. 10(b) shows a side view of an alternate embodiment of the lower portion; and

FIG. 11 is a schematic diagram of a system according to a preferred embodiment of the present invention.

### DESCRIPTION OF THE PREFERRED EMBODIMENT

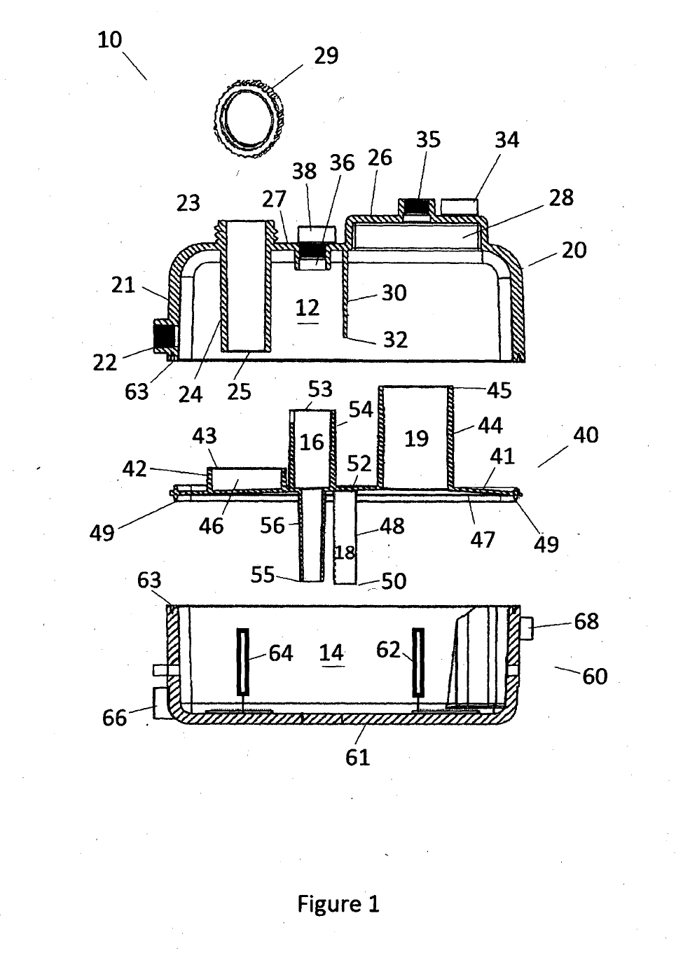

Referring to FIG. 1, there is shown a sectional and exploded view of an electrolytic cell 10 according to a preferred embodiment of the apparatus of the present invention. The electrolytic cell 10 comprises an upper portion 20, a centre plate 40 and a lower portion 60 and in use the electrolytic cell 10 defines an upper chamber 12 and a lower chamber 14 spaced apart and separated by the centre plate 40.

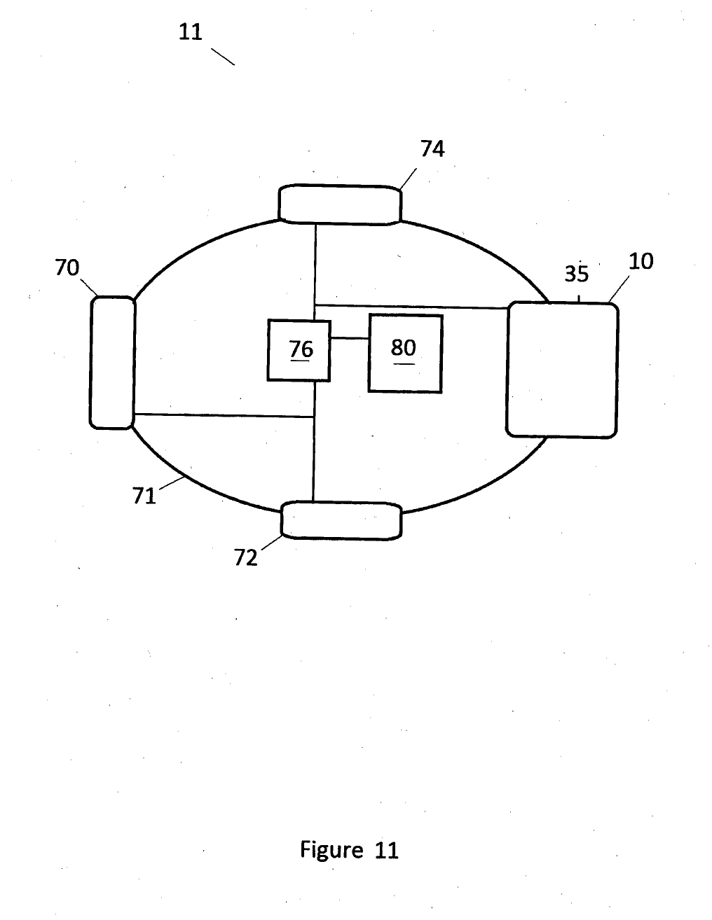

As seen in FIG. 1 the upper portion 20 comprises a fluid inlet 22 opening into the upper chamber 12 through a side wall 21. In use the fluid inlet 22 is arranged to be in fluid communication with a complementary fluid conduit 71 (see FIG. 11) such that a flow of electrolyte may pass from the fluid conduit 71 through the fluid inlet 22 and into the upper chamber 12.

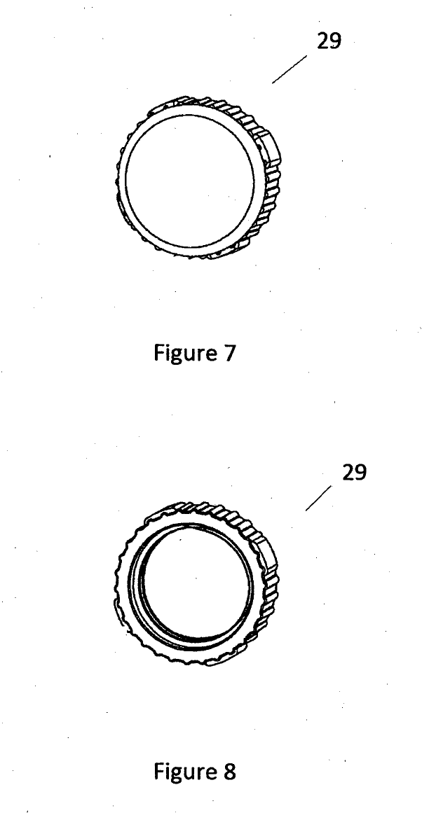

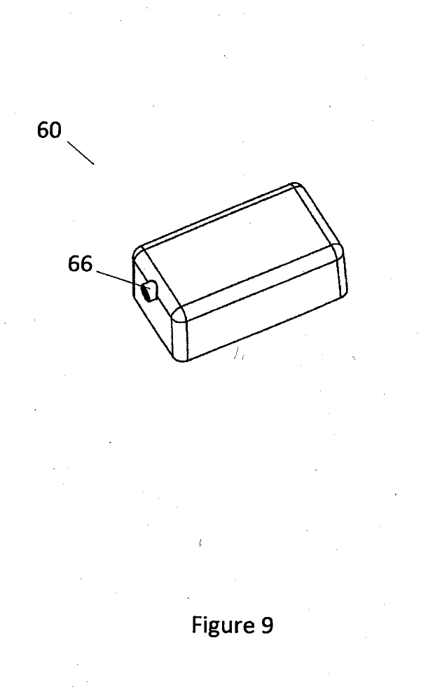

The upper portion 20 further comprises an electrolyte filler opening 23 comprising an aperture passing through an upper wall 27. As seen in FIG. 1 the electrolyte filler opening 23 of the upper portion 20 preferably comprises a downwardly projecting tube 24, the tube 24 having an open distal end 25 arranged to be disposed below an operational electrolyte level. In the embodiment shown in FIGS. 1 and 5 the downwardly projecting tube 24 is arranged to have the distal end 25 adjacent a complementary fluid trap 42 which is disposed on an upper surface 41 of the centre plate 40. The fluid trap 42 comprises a cylindrical configuration having a closed proximal end and an open distal end 43 extending upwardly into the upper chamber 12. The fluid trap 42 defines an internal space 46 arranged to substantially receive the downwardly projecting tube 24 open distal end 25 therein for providing an air locked space within the tube 24 thereby avoiding the collection of any electrolysis gases within the tube 24. It should be understood that this feature improves the safety of the present invention by limiting the escape of electrolysis gases from the electrolytic cell 10. The electrolyte filler opening 23 is provided with a complementary cap 29 as seen in FIGS. 7 and 8 such that the upper chamber 12 may be accessed for adding electrolyte as required. Preferably the cap 29 and the electrolyte filler opening 24 have complementary threads so that the cap 29 may be removably fastened to upper portion 20 and remain securely fastened under operating conditions.

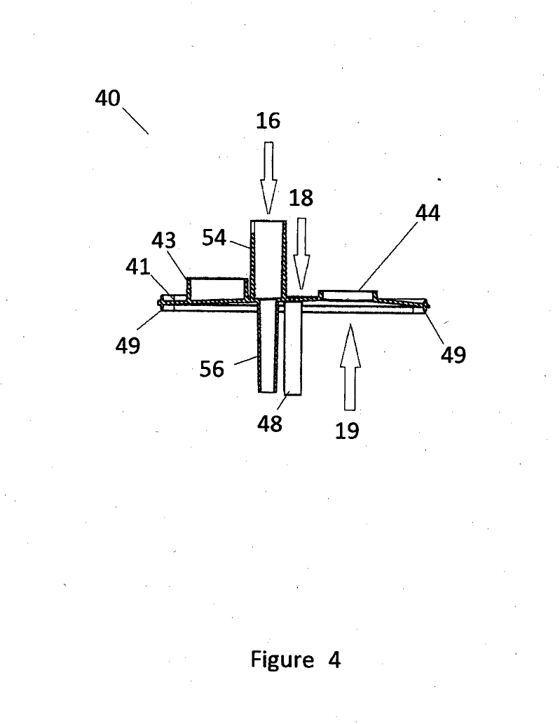

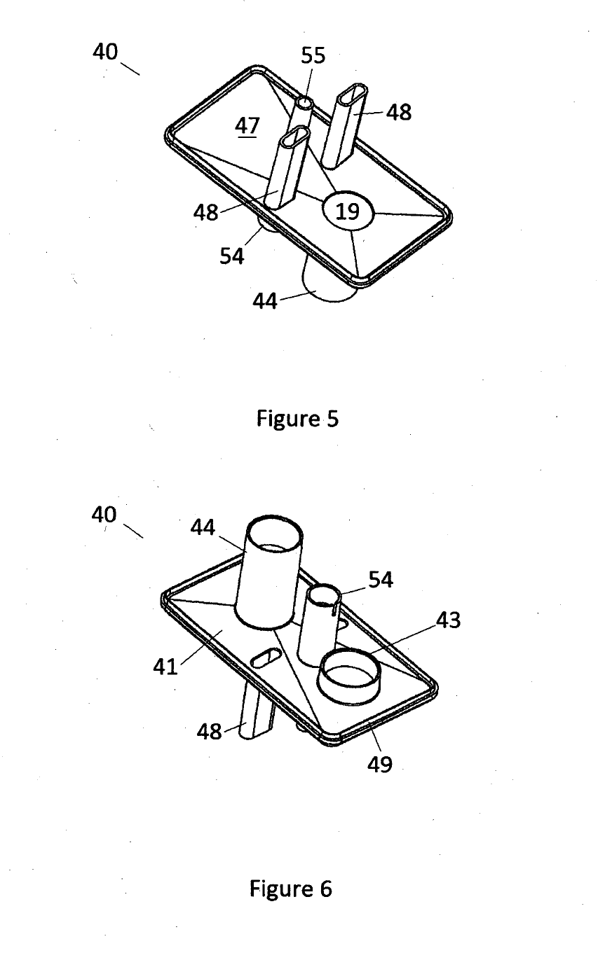

It is to be understood that, the upper portion 20, centre plate 40 and lower portion 60 of the electrolytic cell 10 are sealed to one another such that the electrolytic cell 10 provides a flow path along which electrolyte is caused to flow from the fluid inlet 22 and into the upper chamber 12 of the electrolytic cell 10. The flow of electrolyte is then passes from the upper chamber 12 into the lower chamber 14 via a first flow path 18 comprising one or more conduits 48 disposed along the centre plate 40 as seen in FIG. 4. In the present embodiment the centre plate 40 comprises two conduits 48 disposed side by side and located in a generally central position of the centre plate 40. Each conduit 48 comprises an open ended drop tube defining the first flow path 18. Each conduit 48 extends downwardly into the lower chamber 14. The conduit 48 is arranged to have a first open end 52 proximal to the centre plate 40 and a second distal open end 50 in close proximity to a lower wall 61 of the lower portion 60. Preferably the distal open end 50 of each conduit 48 is within 3 mm of the lower wall 61.

It should be understood that the second distal open end 50 is arranged to be below an operational electrolyte level of the electrolytic cell 10 when in use thereby eliminating any electrolytic gases produced in the lower chamber 14 escaping via the first flow path 18 into the upper chamber 12 of upper portion 20.

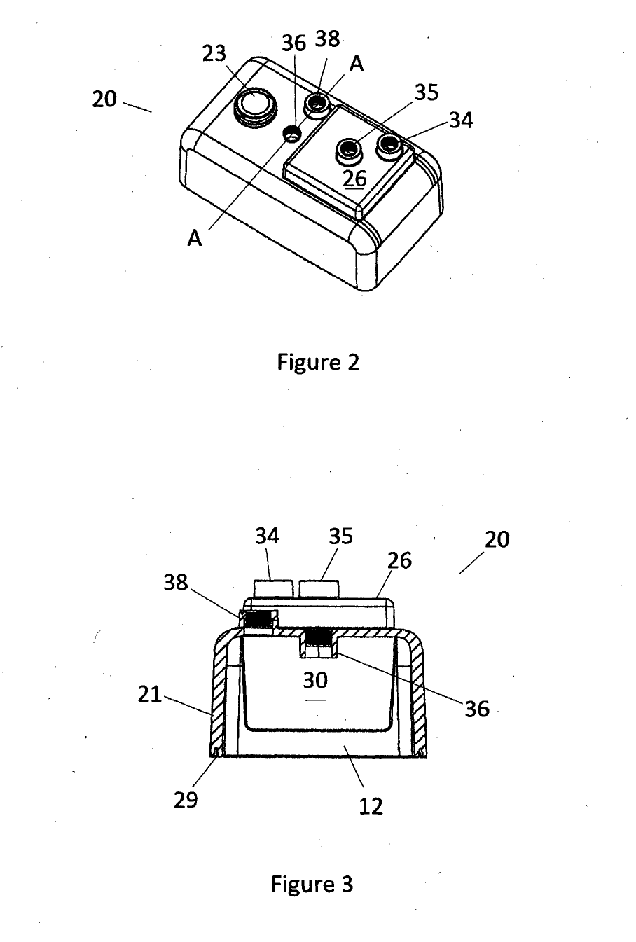

As seen in FIGS. 1, 2 and 3 the upper portion 20 is further arranged to comprise a gas trap 26 for collecting electrolysis gases. In the present embodiment the gas trap 26 is disposed within the upper chamber 12 adjacent the upper wall 27 of the upper portion 20. The gas trap 26 is arranged to define an internal space 28 for collecting electrolysis gases that have risen from the lower portion 60 via a second flow path 19 which is defined by an upwardly projecting gas shoot 44 of the centre plate 40. The gas trap 26 comprises a gas outlet orifice 35 for connection with a conduit 71 (see FIG. 11) for the extraction of the electrolysis gases from the electrolytic cell 10. Typically, for example, the gas outlet orifice 35 may connect to an inlet manifold fuel supply apparatus or injector of an internal combustion engine (not shown). In this instance the inlet manifold may be in negative pressure conditions and therefore provide a vacuum for assisting the drawing electrolysis gases out from the electrolytic cell 10.

The gas trap 26 further comprises a valve 34 disposed in the upper wall 27 which is openable at a predefined pressure within the electrolytic cell 10 for dispersing excessive pressure or gases from within the electrolytic cell 10 thereby avoiding a build up of gases within the cell 10.

As seen in FIGS. 1 and 3, a curtain 30 is disposed to extend downwardly from the upper surface 27 of the upper portion 20 and into the inner chamber 12. The curtain 30 is configured to provide a gas impervious barrier between the gas trap 26 and the fluid inlet 22. The curtain 30 increases the volume of space 28 and acts as a baffle to limit undesired movement or sloshing of electrolyte. It should be understood that a lower end 32 of the curtain 30 is arranged to be substantially below an operational electrolyte level of the upper portion 20.

Preferably the gas shoot 44 has an open ended cylindrical configuration with one distal end 45 which substantially protrudes into the upper chamber 12. It should be understood that the gas shoot 44 distal end 45 is arranged to be disposed above an operational electrolyte level of the upper portion 20.

As seen in FIGS. 1 and 4 the centre plate 40 also comprises a passage 16 therethrough defined by an upwardly projecting tube 54 having an upper open end 53 for engaging with an opening 36 disposed in the upper wall 27 of the upper portion 20. The passage 16 is further defined by a complementary downwardly projecting tube 56 having a lower open end 55 proximal to the lower wall 61 of the lower portion 60. Preferably at least the downwardly projecting tube 56 is tapered such that the upper open end 53 has greater sectional dimensions that the lower open end 55. In the preferred embodiment of the present invention the opening 36 comprises a 5 mm gas thread.

The opening 36 and/or upper projecting tube 54 may be used to accommodate an electrolyte level sensor (not shown), preferably the electrolyte level sensor comprises an ultra sonic depth sensor for providing an accurate measurement of the electrolyte level within the lower chamber 14. The tube 53 may project to within 3 mm of the lower wall such that the operational electrolyte level is above the tube 54 opening to avoid electrolysis gas escaping from the lower chamber 14.

As seen in FIGS. 1, 2 and 3 the upper portion 20 preferably comprises an additional aperture 38 adapted to permit a suitable temperature sensor access to the upper chamber 12 for providing electrolyte temperature measurements to be taken.

In a preferred embodiment of the present invention the cell 10 lower chamber 14 comprises 11 to 28 electrode plates 62, 64. A flow rate of the resulting electrolysis gas produced may be around 2 lt/min. It should be understood the flow rate of electrolysis gas may be regulated by adjusting the control module 76 by controlling the amperage applied to the cell 10.

As seen in FIGS. 4 and 5 a lower surface 47 of the centre plate 40 is configured to provide an upwardly disposed funnel for assisting the collection and channelling produced of electrolysis gases into the gas shoot 44 for passage through to the gas trap 26 and/or extraction from the cell 10.

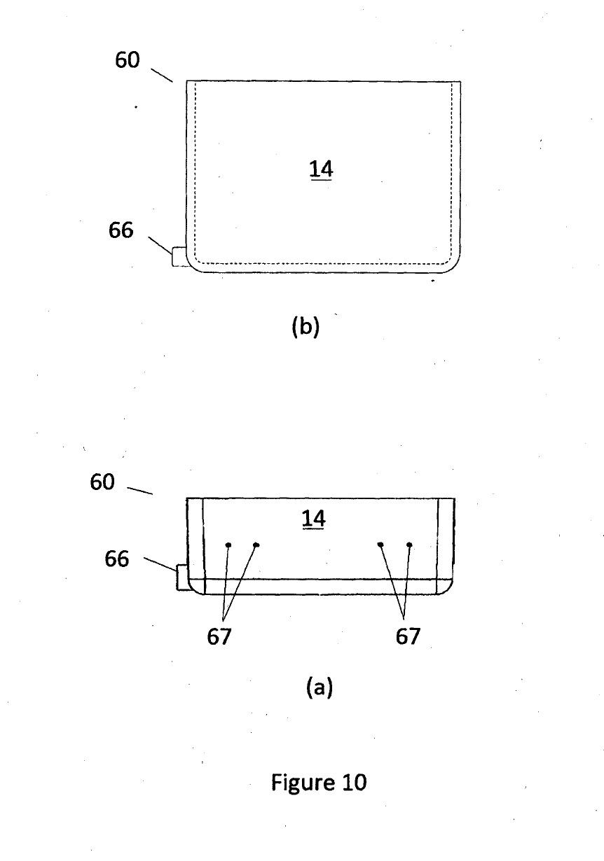

As seen in FIGS. 10(a) and (b) the lower portion 60 of the present invention defines the lower chamber 14 for holding a reservoir of electrolyte for undergoing an electrolysis reaction for producing electrolysis gases. As electrolyte flows along the first flow path 18 (see FIG. 4) and enters the lower chamber 14 it comes into contact with a plurality of electrode plates 62, 64 (see FIG. 1). In the preferred embodiment of the present invention there are 46 electrode plates in total with an equal number connected to opposite poles of a source of electric energy. It is envisaged the plurality of electrode plates 62, 64 will be substantially immersed within the reservoir of electrolyte.

In a preferred embodiment a majority of the electrodes 62, 64 comprise a high quality titanium material which majority are used together with a minority of electrodes 62, 64 comprising an iridium based conductive material to assist in the electrolysis reaction. It has been advantageously found that an optimum ratio of 42.8% or (3 of every 7) electrodes may comprise an iridium based material.

As shown in FIG. 10(a), the electrodes 62, 64 may be held in position by fasteners 67. The fasteners may comprise bolts comprising a grade two titanium material. Any nuts or washes (not shown) may also be coated in a titanium material.

As seen in FIGS. 1 and 10(a) the lower portion 60 provides a fluid outlet 66 and a fluid overflow 68. The fluid outlet 66 is arranged to communicate with a complementary conduit 71 which may be connected either directly or indirectly to the fluid inlet 22 of the upper portion 20 thereby permitting a flow of electrolyte external to the electrolytic cell 10 as seen in FIG. 11. Preferably the fluid outlet 66 is disposed proximal to the lower surface 61 of the lower portion 60 whereas by contrast the fluid overflow 68 is disposed proximal to the centre plate 40.

In alternate embodiment of the electrolysis cell, the lower portion 60 may comprise a plurality of individual cells. In such an embodiment it is envisaged the lower portion 60 may have an increased dimensions as seen in FIG. 10(b) thereby providing for a lower chamber 14 having a greater volume.

It is envisaged there may be a plurality of individual minor cells (not shown) arranged within the lower chamber 14. Each minor cell comprising one or more respective electrodes 62, 64 for an increased production of electrolyte gases and an improved electrolytic cell 10 gaseous output. Preferably there will be 2 or 4 minor cells with each respective minor cell comprising 7 electrode plates 62, 64 of which 4 plates 62, 64 comprise titanium material and the remaining 3 plates 62, 64 comprise the iridium based material.

As seen in FIG. 11 the system 11 according to a preferred embodiment of the present invention comprises the electrolysis cell 10 and a heat exchanger 70 in fluidic communication. A filter 72, a fluid pump 74, a control module 76 and a display unit 80 are also present in the preferred embodiment.

It should be understood that it is found that the present invention functions most effectively using a water based electrolyte for producing electrolysis gases of hydrogen and oxygen in specific conditions. In particular the temperature of the electrolyte undergoing an electrolysis reaction with the electrode plates 62, 64 is preferably kept within a temperature range 45-60° C., and preferably has a temperature of 46° C. In order to control the electrolyte temperature the present invention cycles electrolyte from the lower portion 60 to the upper portion 20 via a heat exchanger 70. In the preferred embodiment the system 11 the heat exchanger 70 comprises a nylon electronic heat exchanger or thermoelectric cooler for example. Alternatively a standard radiator type heat exchanger 70, preferably formed from an aluminium material, may be used. It should be understood that alternate forms or combinations of heat exchangers 70 may be used with the present invention in order to limit the electrolyte temperature within specified levels. The heat exchanger 70 may be capable of multiple exchanges of heat and capable of cooling a fluid below ambient temperature.

The fluid pump 74 is preferably controlled by the control module 76 and activated to cycle electrolyte out from the lower portion 60 and into the heat exchanger 70 for heat to be removed from the electrolyte. It is to be understood that the control module 76 is in communication with the temperature sensor (not shown) and may be programmed to selectively limit the temperature range of electrolyte used in the present invention to remain within the prescribed operational limits by operating the pump 74, to cycle the electrolyte through the conduit 71 and the heat exchanger 70.

In the preferred embodiment of the system 11 of the present invention the fluid pump 74 comprises a 1.6 bar 1.5 amp 12-24 DC volt high volume pump with a relief valve built in.

Preferably the water filter 72 is in fluid connection with the conduit 71 for removing any impurities present in the electrolyte. It should be understood that a preferred embodiment of the present invention uses an electrolyte comprising a pure source of water substantially free from impurities, such as deionized or distilled water for example.

The electrolytic cell 10 of the present invention is preferably made from a polymer or nylon material having a wall thickness of around 8 mm. As seen in FIG. 1 the centre plate 40 comprises one or more flanges 49 running about a periphery of the centre plate. Each flange 40 is arranged to be received in a complementary groove 29, 63 in the upper portion 20 and/or the lower portion 60 to improve a structural integrity of the cell 11. The upper portion 20, centre plate 40 and the lower portion 60 may be joined together by any known means, such as adhesives or plastic welding for example, however it is to be understood that the electrolytic cell 10 can preferably be able to contain internal pressures of around 8 Bar.

It is envisaged the apparatus 10 and the system 11 according to the present invention will be used to enhance a diesel fuelled internal combustion engine. However a skilled addressee will understand that the apparatus 10 and/or system 11 according to the present invention may be used with any internal combustion engine or other application where a combustible gas is required, such as a barbeque for example.

In use, the system of the present invention is mounted to a vehicle such that the gas outlet orifice 35 is in fluid communication with an intake manifold of an internal combustion engine (not shown). Accordingly one or more mounting lugs or flanges may be provided on the electrolysis cell 10 for securing the apparatus to a vehicle for example. Typically the control module 76 and display unit 80 will be located within the reach and vision of a driver or operator. The display unit 80 is connected to the control module and has a screen capable of representing variables of the present invention to provide an interface for the operator to monitor the system 11 variables such as electrolytic cell 10 water level, water temperature, and the electrical current/voltage applied across the electrode plates 62, 64 for example.

The display unit 80 may also provide means for the operator to selectively vary one or more system variables as required.

The control module 76 may comprise communication means (not shown) including USB or wireless connectivity such that updates to the control module computer software may be installed as required.

In use electric energy is applied to the electrodes 62, 64 such that a potential difference of 3-12v induces an electric current to be passed between the electrode plates 62, 64. An electrolysis reaction then occurs within the electrolytic cell 10 thereby producing hydrogen and oxygen gas. The apparatus 10 of the present invention utilises the relative density of the electrolyte and the gas to separate the produced gases with the gases rising to the top of the lower chamber 14 and being channeled into the gas trap 26 via the contoured centre plate 40 and the flow path 19.

The gases collected in the gas trap 26 may then be extracted for use as required such as for example through a conduit connecting to an intake manifold of an internal combustion engine. Once therein the gases mix with the air/fuel mixture of the internal combustion engine to enhance the combustion, thereby decreasing the amount of fossil fuels required to operate the engine.

It is envisaged that 4 litres of electrolyte will be enough to provide electrolysis gases for a 1000 km trip and reducing fossil fuels consumption by as much as 58% during the trip.

Modifications and variations as would be apparent to a skilled addressee are deemed to be within the scope of the present invention.

1. An apparatus for use in enhancing and/or supplementing a fuel supply of an internal combustion engine, the apparatus comprises a first chamber and a second chamber and defines a first flow path for an electrolyte to flow from the first chamber to the second chamber, and a second flow path for an electrolysis gas to flow from the second chamber, the second chamber comprises at least one electrode substantially arranged to be in electrical communication with a power source, characterised in that in use a flow of electrolytic fluid passes through the first flow path from the first chamber to the second chamber for undergoing an electrolytic reaction with the electrode to form an electrolysis gas, the electrolysis gas flowing through the second flow path for extraction from the apparatus.

2. An apparatus according to claim 1, characterised in that the first chamber is disposed above the second chamber such that the first flow path defines a downward flow and the second flow path defines an upward flow.

3. An apparatus according to claim 1, characterised in that the electrolyte comprises a water based fluid and the electrolysis gas comprises hydrogen and oxygen.

4. An apparatus according to claim 1, characterised in that the apparatus comprises an upper portion and a lower portion, the upper portion and the lower portion being connected together, and spaced apart from one another, by an intermediate portion.

5. An apparatus according to claim 4, characterised in that the first chamber is defined by the upper portion and an upper surface of the intermediate portion.

6. An apparatus according to claim 4, characterised in that the second chamber is defined by the lower portion and a lower surface of the intermediate portion.

7. An apparatus according to claim 4, characterised in that the intermediate portion defines at least in part the first flow path for enabling electrolytic fluid to pass from the upper portion to the lower portion.

8. An apparatus according to claim 4, characterised in that the intermediate portion defines at least in part the second flow path for enabling electrolysis gas to pass from the lower portion.

9. An apparatus according to claim 8, characterised in that the second flow path connects the lower portion with a gas trap.

10. An apparatus according to claim 9, characterised in that the upper portion comprises the gas trap.

11. An apparatus according to claim 10, characterised in that the gas trap is spaced apart from the first chamber by, at least in part, a descending curtain.

12. An apparatus according to claim 4, characterised in that the intermediate portion comprises an upper surface for defining at least in part the first chamber and/or the gas trap, and a lower surface for defining at least in part the second chamber, the lower surface further comprising an upwardly funnelled portion proximal to the second flow path for assisting in the collection of electrolysis gas.

13. An apparatus according to claim 1, characterised in that the second flow path is in fluidic communication with a pressure relief valve which is openable at a predefined pressure.

14. An apparatus according to claim 1, characterised in that the apparatus comprises a plurality of electrodes.

15. An apparatus according to claim 14, characterised in that one or more electrodes comprise a metallic plate comprising titanium material.

16. An apparatus according to claim 14, characterised in that one or more electrodes comprise an iridium based material.

17. An apparatus according to claim 1, characterised in that the apparatus comprises an electrolytic fluid inlet and an electrolytic fluid outlet.

18. An apparatus according to claim 1, characterised in that the apparatus comprises an electrolytic fluid level sensor.

19. A system, for measuring and regulating operational parameters of an electrolytic fluid used to produce combustible gas for enhancing and/or supplementing a fuel supply for an internal combustion engine, the system comprising an electrolytic cell having at least an electrolytic fluid inlet and an electrolytic fluid outlet, the inlet and the outlet being communicable via a fluidic circuit, the fluidic circuit providing a flow path through which the electrolytic fluid may pass, characterised in that the circuit comprises any one or more of the following features: a pump for urging the electrolytic fluid about the fluidic circuit, filter means for purifying the electrolytic fluid as it passes along the fluidic circuit, heat exchanger means for varying an electrolytic fluid temperature and a control module.

20. A system according to claim 19, characterised in that the control module comprises a display unit for providing a visual representation of the system to an operator and an interface for manual control or adjustment of one or more system variables.

21. A system according to claim 20, characterised in that one or more system variables may comprise a voltage and/or current supply to the electrolytic cell, an electrolytic fluid temperature, a level of electrolytic fluid within the cell, and/or flow rate of the electrolytic fluid.

22. A system according to claim 19, characterised in that, in use the electrolytic fluid is substantially maintained with a temperature range of 30° C. to 60° C.

23. A system according to claim 19, characterised in that, in use the electrolytic fluid is substantially maintained with a temperature range of 45° C. to 52° C.

24. A system according to claim 19, characterised in that the electrolytic fluid is substantially maintained at a temperature of 46° C.

25. A system according to claim 19, characterised in that the heat exchanger means comprises a nylon electronic heat exchanger.

26. A system according to claim 19, characterised in that the electrolytic cell comprises an apparatus that comprises a first chamber and a second chamber and defines a first flow path for an electrolyte to flow from the first chamber to the second chamber, and a second flow path for an electrolysis gas to flow from the second chamber, the second chamber comprises at least one electrode substantially arranged to be in electrical communication with a power source, characterised in that in use a flow of electrolytic fluid passes through the first flow path from the first chamber to the second chamber for undergoing an electrolytic reaction with the electrode to form an electrolysis gas, the electrolysis gas flowing through the second flow path for extraction from the apparatus.
